(19) United States
(12) Patent Application Publication
(10) Pub. No.: US 2026/0320703 A1
(43) Pub. Date: Oct. 15, 2026

(54) AGENTIC-APPROACH TOWARDS APPLYING DOCUMENT-BASED ACCOUNTING SPECIFICATIONS TO ALIGN TRANSACTIONS WITH A STANDARD

(71) Applicant: M3, LLC, Lawrenceville, GA (US)

(72) Inventors: Parag Doshi, Lawrenceville, GA (US); Phillip Steven Woods, Lawrenceville, GA (US); Darren Greenwald, Lawrenceville, GA (US)

(21) Appl. No.: 19/178,962

(22) Filed: Apr. 15, 2025

(51) Int. Cl. G06Q 40/12; G06Q 50/12

(52) U.S. Cl. CPC G06Q 40/126; G06Q 50/12

(57) ABSTRACT

In an aspect of the disclosure, a method, a computer-readable medium, and a system are provided. The system may include one or more computing devices. The one or more computing devices receive a request to map a property management system (PMS) transaction to Uniform System of Accounts for the Lodging Industry (USALI) standards. The one or more computing devices perform a search in a vector database for a prior mapping of the PMS transaction. When the prior mapping is not found for the PMS transaction, the one or more computing devices generate, using a retrieval augmented generation (RAG) process accessing a vectorized USALI specification, a USALI-compliant mapping comprising a USALI department and a USALI account. The one or more computing devices store the USALI-compliant mapping in the vector database for use in subsequent mapping operations.

### BACKGROUND

### FIELD

The present disclosure relates generally to computer systems, and more particularly, to techniques of automatically mapping property management system transactions into standardized chart of accounts using semantic search and retrieval augmented generation with an agentic approach.

### BACKGROUND

The hospitality industry relies heavily on manual processes to reconcile financial transactions across different property management systems (PMS) with standardized accounting practices. Hotels typically use various software applications for managing bookings and operations, with hotel brands often dictating which PMS must be used. These systems generate transaction data using their own proprietary account structures and naming conventions, creating significant challenges when trying to standardize accounting across properties.

The Uniform System of Accounts for the Lodging Industry (USALI) was developed to bring uniformity to hospitality accounting practices. This extensive specification, spanning over 500 pages, provides detailed guidance on how to classify and categorize various hotel transactions into standardized departments and accounts. However, most PMS software providers could not justify the enormous cost and effort required to retrofit their systems to natively support USALI compliance. As a result, hotels were forced to manually map their daily transactions from their PMS formats into USALI-compliant accounts - a time-consuming, error-prone process that could take weeks or months to complete during customer onboarding. These transactions encompass a wide range of hotel operations: reservations (managing guest bookings and group reservations), front desk operations (handling check-in/check-out, room assignments, and guest inquiries), housekeeping (assigning tasks, tracking room status, and managing housekeeping staff), rate and occupancy management (setting and adjusting room rates, managing inventory, and tracking occupancy), financial transactions (processing payments, generating invoices, and managing accounting tasks), channel management (distributing hotel availability and rates across various online travel agencies and other channels), and guest data and CRM (centralizing guest information to personalize experiences and improve customer loyalty).

This manual mapping process required extensive training of employees to understand the semantic relationships between different account names that might refer to the same type of transaction across different systems. For example, cleaning supplies might be categorized as a room expense in one system but as a housekeeping expense in another. Collectively, staff needed to become subject matter experts across more than seven hundred different PMS applications while maintaining deep knowledge of the constantly updated USALI specification. The manual nature of this work not only created significant delays in onboarding new customers but also introduced risks of PMS data mapping errors that could impact financial reporting accuracy and regulatory compliance.

The traditional approach also struggled to maintain consistency as the USALI specification evolved over time. Hotels would need to regularly review, update, and add to their mapping rules to stay current with specification changes. Additionally, the manual process provided no systematic way to capture and reuse mapping decisions across properties, meaning similar mapping work often had to be repeated for each new customer implementation. This resulted in an unsustainable scaling problem as hospitality solution providers attempted to serve more customers while maintaining mapping accuracy and USALI compliance.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating the architecture and operational workflow of a PMS Mapper system.

FIG. 3 is a diagram illustrating a transaction mapping table.

FIG. 4 is a flow chart of a method for mapping PMS transactions to USALI standards.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

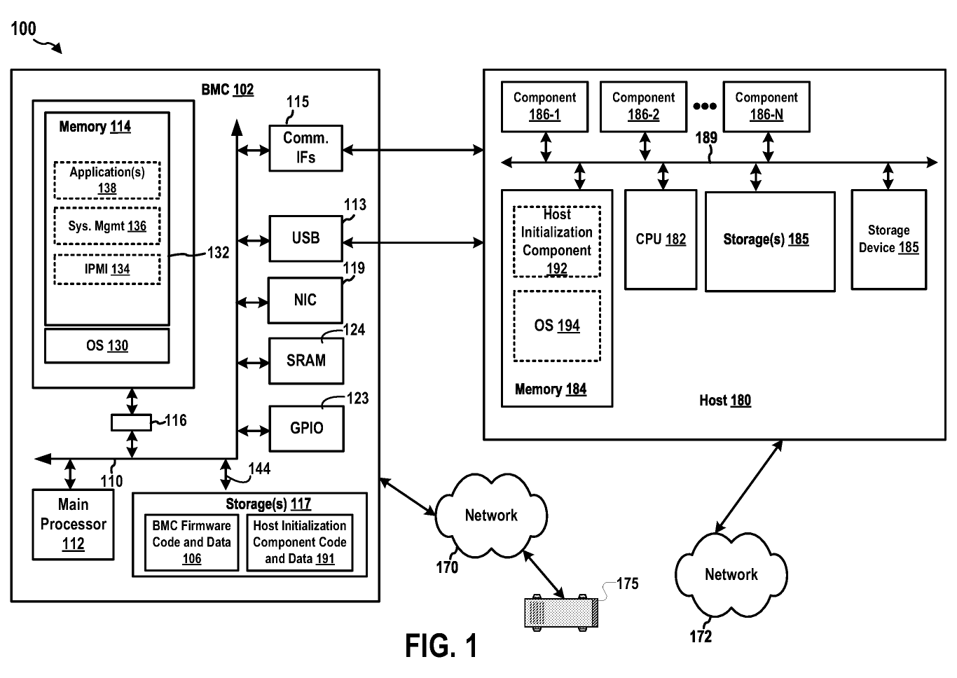

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interfaces 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

The hospitality industry relies heavily on various software applications for managing bookings and property operations. A hospitality solution provider, in the broadest sense, plays a crucial role in the back-office, or FinOps, for hospitality. This includes the accounting system, profitability optimization, labor tracking, and gaining insights into aspects like seasonality. While front-office systems, such as Property Management Systems (PMS), Central Reservation Systems (CRS), and Revenue Management Systems (RMS), and Point of Sale (POS) Systems handle reservations and pricing, the hospitality solution provider focuses on integrating data from these diverse sources (over potentially thousands of different providers) into a unified accounting system.

The core challenge arises during customer onboarding, where hotel operators, owners, or operating companies often use a multitude of PMS, property management, and central reservation systems, dictated by brands like Hilton, Marriott, and IHG. Integrating these disparate systems with the hospitality solution provider’s core SaaS accounting product, such as particular accounting software, presents a significant hurdle. A crucial aspect of this integration is Property Management System (PMS) mapping.

This mapping involves correctly categorizing daily transactional data – including room reservations, amounts paid, room rates, and additional purchases (e.g., gift shop items, food and beverage, other services) – into the appropriate accounts for bookkeeping and accounting, ensuring auditability and Generally Accepted Accounting Principles (GAAP) compliance. To standardize accounting practices in the lodging industry, the Uniform System of Accounts for the Lodging Industry (USALI) specification has been established. USALI dictates how expenses should be categorized and defines a standard chart of accounts, allowing for some customization per hotel, property, or brand.

However, retrofitting existing PMS software to natively conform to USALI is often impractical and costly for software development organizations. Consequently, hotel operators are typically forced to manually map their daily transactions to the USALI chart of accounts. This manual process is extremely time-consuming, error-prone, and requires significant training for employees to understand the semantic nuances of different account names that may refer to the same underlying transactions. The USALI specification, while intended to provide uniformity, is an extensive and frequently updated document, making it impractical for manual processing and constant upkeep.

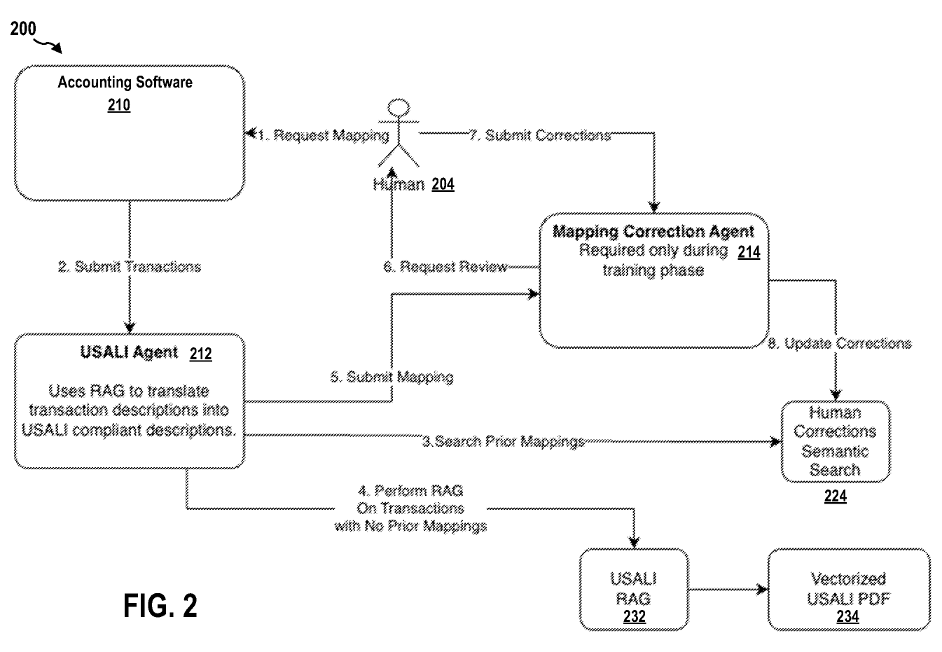

FIG. 2 contains a diagram 200 illustrating the architecture and operational workflow of the PMS Mapper system, which automates the mapping of PMS transaction data into USALI compliant chart of accounts. The system integrates multiple specialized software components and human oversight to provide accurate, efficient, and scalable transaction mapping.

The workflow begins with a human user 204 initiating a mapping request by interacting with an accounting software 210. The accounting software 210 serves as the primary interface and coordination point for the mapping process. Upon receiving the mapping request, the accounting software 210 submits the transaction data to a USALI agent 212. The USALI agent 212 is a specialized AI-based component designed to semantically interpret and classify transaction descriptions into appropriate USALI-compliant account and department categories. It utilizes Retrieval Augmented Generation (RAG) techniques to accurately translate diverse and semantically varied transaction descriptions into standardized USALI terminology.

The USALI agent 212 first performs a hybrid search (combining semantic and keyword-based searches) within a corrections/semantic search component 224, which maintains a vector database containing historical mappings and previously captured human corrections. If a suitable prior mapping is found, the USALI agent 212 directly uses this existing mapping, significantly reducing computational overhead and improving response times. If no suitable prior mapping is found, the USALI agent 212 proceeds to perform a RAG-based inference using a USALI RAG component 232. The USALI RAG component 232 accesses a vectorized USALI PDF 234, which is a vector-embedded representation of the comprehensive USALI specification document. By using this vectorized document, the USALI RAG component 232 can efficiently retrieve relevant semantic context from the USALI specification to generate accurate mappings.

Once the USALI agent 212 completes the mapping process, it submits the proposed mappings to a mapping correction agent 214. The mapping correction agent 214 is specifically employed during the initial training phase or when human oversight is required to validate and correct ambiguous or uncertain mappings. The mapping correction agent 214 requests a human review from the human user 204, presenting the mappings along with confidence scores assigned by the USALI agent 212. The human user 204 reviews these mappings and, if necessary, submits corrections back to the mapping correction agent 214. These corrections may also be updated and stored within the corrections/semantic search component 224. Over time, this continuous feedback loop progressively enriches the vector database with accurate, human-validated mappings, enhancing the overall reliability and efficiency of the hybrid search process.

Due to inherent ambiguities and variations in the USALI specification and the diverse terminologies used by different PMS providers, fully automated mapping can occasionally produce less-than-ideal results. By incorporating human corrections into the corrections/semantic search component 224, the system effectively learns from human expertise, thereby gaining a human-like experiential understanding of nuanced semantic variations. This design ensures that the system continually improves its accuracy and reduces the need for human intervention over time.

Additionally, the hybrid search approach, which prioritizes historical mappings and human corrections stored in the vector database, significantly reduces the token usage and computational cost associated with frequent RAG-based inferences. As the corrections/semantic search component 224 becomes increasingly populated with accurate mappings, the hybrid search mechanism becomes the dominant means of mapping, further enhancing system efficiency and scalability.

The accounting software 210 implements an automated mapping system that translates PMS transaction data into standardized USALI-compliant or customer edited account names. This translation addresses a fundamental challenge in hospitality accounting where diverse transaction descriptions from multiple PMS systems must be correctly categorized according to the USALI specification or customer-driven variations.

When the human user 204 initiates a mapping request through the accounting software 210, the system begins a multi-stage process involving both automated agents and selective human oversight. The accounting software 210 first transmits the transaction data to the USALI agent 212, which functions as the primary semantic interpreter for transaction classifications.

The USALI agent 212 employs a two-phase approach to mapping. In the first phase, it queries the corrections/semantic search component 224 to determine if identical or semantically similar transactions have been previously mapped. The corrections/semantic search component 224 maintains a vector database containing both historical mappings and human-validated corrections, allowing rapid retrieval of established mappings without requiring additional computational resources.

When the corrections/semantic search component 224 cannot provide a suitable match, the USALI agent 212 initiates the second phase by engaging the USALI RAG component 232. The USALI RAG component 232 interfaces with the vectorized USALI PDF 234, which contains the complete USALI specification in a vector-embedded format. This vectorization enables efficient semantic retrieval and interpretation of the USALI guidelines combined with customer-specific variations of account names.

The mapping correction agent 214 serves as a quality control mechanism during the system’s training phase and for transactions with uncertain classifications. Upon receiving mapped transactions from the USALI agent 212, the mapping correction agent 214 facilitates human review when necessary. The human user 204 can then examine the proposed mappings and submit corrections through the mapping correction agent 214, which updates the corrections/semantic search component 224 with the validated mappings.

This continuous feedback mechanism creates a self-improving system where human expertise progressively enhances the accuracy of future mappings. For example, when mapping cleaning supplies expenses, different properties might categorize these items differently - some as room expenses, others as housekeeping expenses. The system captures these property-specific variations through human corrections, building a comprehensive understanding of semantic variations across different hotel operations.

The system’s hybrid search approach, combining semantic and keyword-based searches, reduces computational overhead by prioritizing the reuse of validated mappings stored in the corrections/semantic search component 224. As the vector database grows with accurate mappings, the system increasingly relies on direct retrieval rather than performing new RAG-based inferences, thereby improving both efficiency and response times.

Through this architecture, the system transforms what was historically a manual, time-intensive process requiring extensive human expertise into an automated operation that maintains high accuracy while significantly reducing processing time. The integration of human oversight with automated agents creates a robust system capable of handling the semantic complexities inherent in hospitality accounting while maintaining compliance with USALI standards.

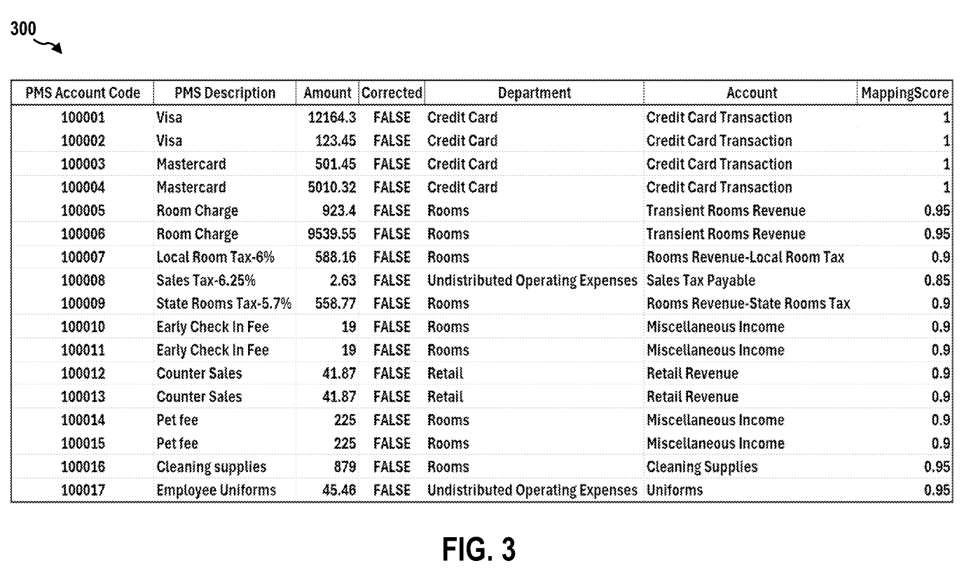

FIG. 3 is a diagram 300 illustrating a transaction mapping table that demonstrates how the PMS Mapper system translates PMS transaction descriptions into standardized USALI-compliant accounts and departments. The table presents a comprehensive view of the mapping process, showing various transaction types commonly encountered in hospitality operations and their corresponding USALI classifications.

The transaction mapping table contains multiple columns that organize the mapping data. The leftmost columns, "PMS Account Code" and “PMS Description," represent account codes and the original transaction descriptions as they appear in the property management system. These descriptions vary widely based on the specific PMS being used and may include payment methods (such as Visa, Mastercard, American Express), room-related charges (Room Charge, Early Check In Fee, Smoking Fee), tax items (Local Room Tax-6%, Sales Tax-6.25%, State Rooms Tax-5.7%), retail transactions (Counter Sales, Gift Sales, Merchandise Sales), and operational expenses (Cleaning supplies, Employee Uniforms, Utility Costs).

The "Amount" column indicates the monetary value associated with each transaction, representing the financial impact of each entry. The "Corrected" column, populated with "FALSE" values throughout this example, indicates whether a human user has manually overridden the system-generated mapping. When a user disagrees with the automated mapping and provides a correction, this field would be set to "TRUE," signaling that the mapping reflects human expertise rather than the system’s original determination.

The "Department" and "Account" columns display the standardized classifications assigned by the PMS Mapper system or by historical customer-desired variations. These classifications may conform to the Uniform System of Accounts for the Lodging Industry (USALI) specification, providing consistency across different properties and management systems. For instance, both Visa and Mastercard transactions are mapped to the "Credit Card" department and "Credit Card Transaction" account, while Room Charges are assigned to the "Rooms" department and "Transient Rooms Revenue" account.

The PMS Mapper system is designed not only to conform to the standardized USALI specifications but also to accommodate customer-desired variations in accounting practices. While the USALI framework provides a comprehensive standardization for the lodging industry, many hotel operators have developed their own accounting preferences and customizations over time that may deviate from the strict USALI guidelines. These customer-driven variations represent an important aspect of the mapping process that must be preserved to maintain operational continuity and customer satisfaction.

When a human user reviews and corrects a mapping proposed by the USALI agent, these corrections often reflect not just errors in interpretation but deliberate customizations specific to that customer's accounting practices. For example, while the USALI specification might suggest categorizing a particular fee as "Miscellaneous Income" under the "Rooms" department, a specific hotel chain might prefer to categorize it under a different department based on their internal reporting structure or management preferences. The system captures these customer-specific preferences through the correction mechanism and stores them in the vector database with an association to the specific customer ID.

This capability allows the PMS Mapper system to maintain a historical record of customer-specific mapping preferences, creating a personalized mapping profile for each customer. When processing transactions for a particular customer, the system first checks for any customer-specific mapping variations before defaulting to the standard USALI classifications. The automated mapping process respects and preserves the unique accounting practices of each hotel operator while still maintaining the underlying structure of the USALI framework.

The vector database within the corrections/semantic search component 224 is structured to efficiently retrieve these customer-specific variations. The system can perform targeted searches that prioritize customer-specific mappings when processing transactions for a particular customer. Over time, as more customer-specific variations are captured and stored, the system builds an increasingly accurate profile of each customer's accounting preferences, further reducing the need for human intervention while maintaining alignment with customer expectations.

The rightmost column, "MappingScore," represents the confidence level of the USALI agent 212 in each mapping assignment. This score ranges from 0 to 1, with higher values indicating greater confidence. Perfect confidence (1.0) is shown for credit card transactions, while slightly lower confidence scores (0.95, 0.9, 0.85) are assigned to more complex or potentially ambiguous mappings such as tax items or specialized fees.

The mapping table demonstrates the system’s ability to handle semantic variations in transaction descriptions. For example, both "Early Check In Fee" and "Pet fee" are mapped to the same account ("Miscellaneous Income") under the "Rooms" department, despite having different original descriptions. This illustrates the semantic understanding capabilities of the USALI agent 212, which can recognize that conceptually similar transactions should receive the same USALI classification, even when described differently in the source system. It may also reflected customer-desired variations.

The transaction mapping process begins when the accounting software 210 submits transaction data to the USALI agent 212. The USALI agent 212 first searches for existing mappings in the corrections/semantic search component 224. If no match is found, it utilizes the USALI RAG component 232 and the vectorized USALI PDF 234 to determine the appropriate USALI department and account. The confidence scores shown in the "MappingScore" column guide the human user 204 during review, highlighting which mappings might require closer scrutiny. Transactions with lower confidence scores may be presented to the mapping correction agent 214 for human verification.

When the human user 204 reviews these mappings, they can accept the automated classifications or provide corrections. Any corrections are captured by the mapping correction agent 214 and stored in the corrections/semantic search component 224 for future reference. This continuous feedback loop progressively improves the generative AI system’s accuracy and reduces the need for human intervention over time.

By storing these mappings in a vector database within the corrections/semantic search component 224, the system can efficiently retrieve existing mappings for future transactions, reducing computational overhead and improving response times. This approach addresses the fundamental challenge in hospitality accounting where diverse transaction descriptions from multiple PMS systems must be correctly categorized according to the USALI specification or customer-desired variations, which itself can contain ambiguities and is frequently updated.

The Retrieval Augmented Generation (RAG) technique employed by the PMS Mapper system addresses the challenges associated with accurately mapping PMS transaction data into the USALI compliant chart of accounts. The RAG technique combines the semantic retrieval capabilities of vector databases with the generative reasoning power of a large language model (LLM) to effectively handle complex and semantically ambiguous mappings.

Initially, the PMS Mapper system receives raw transactional data from a PMS, typically in the form of invoice documents or transaction records. These raw documents are converted into structured JSON payloads, which contain transaction descriptions, amounts, and other relevant details. At this stage, the USALI Department and USALI Account fields within the JSON payload are intentionally left blank, as the system’s objective is to populate these fields through automated semantic mapping.

An exemplary prompt for the USALI Agent is as follows: You are a helpful expert on the specification for USALI (Uniform System of Account for the Lodging Industry). USALI provides guidance on how to classify a hotel transaction by Department and the USALI chart of accounts. Your users will be asking how to classify financial transactions described in terms that are semantically similar the USALI accounts. You will use the USALI chart of accounts. You have access to the USALI document that has been processed into a vector store. You will use the account names and account descriptions to determine the Department and the USALI account that should be used. There should be no attempt to use markdown. You will be given a JSON string object. Your objective is to read each element of the “Account to map” property, which is a description of a financial transaction, then find the USALI equivalent USALI account and department, then set the USALI Account property to the USALI account and the USALI Department property to the USALI account department. For each account and department, you assign, determine your certainty of that assignment, and create a float value between 0 and 1 and assign that value to 'Mapping Score', 0 means no confidence, 1 means full confidence. You will then return the modified JSON string. This JSON will be presented to a user to allow them to make any required corrections. You may communicate your result to the Mapping Correction Agent.

The USALI Agent processes a JSON object that adheres to a defined schema that includes the following fields, which are assigned with appropriate values: Customer ID (String), Account to map (String), Account Description (String), Amount (Currency), Corrected (Boolean), USALI Department (String), USALI Account (String), and MappingScore (Float).

The agent is explicitly instructed to avoid using markdown formatting and to focus solely on populating the "USALI Department" and "USALI Account" properties based on the "Account to map" and "Account Description" fields. Crucially, the prompt also directs the agent to assign a "Mapping Score," a floating-point value between 0 and 1, representing the agent’s confidence in its mapping decision. This confidence score plays a vital role in the subsequent human-in-the-loop review process. The prompt defines the structure and expected behavior, enabling consistent and predictable operation of the USALI agent 212. The JSON object is then passed back to the accounting software.

The second agent, the mapping correction agent 214, serves as a quality control mechanism that bridges automated classification with human expertise. This agent receives the mapped transactions from the USALI agent 212 and coordinates the human review process when necessary. The mapping correction agent 214 presents transactions with lower confidence scores to the human user 204 for verification and potential correction. For example, in FIG. 3, the "Sales Tax-6.25%" transaction received a confidence score of 0.85, indicating that this mapping might benefit from human review.

When the human user 204 submits corrections, the mapping correction agent 214 performs two critical functions. First, it updates the current transaction mapping to reflect the human-provided correction. Second, it stores this correction in the corrections/semantic search component 224, creating a persistent record that improves future mapping accuracy. This feedback loop allows the system to accumulate domain expertise over time, reducing the frequency of required human interventions.

The mapping correction agent 214 acts as an intermediary between the automated USALI agent 212 and the human user 204, enabling a feedback loop that improves the system’s accuracy and adapts to the nuances of different property management systems and accounting practices. The mapping correction agent 214 receives the output of the USALI agent 212, which includes the proposed USALI department and account mappings, along with the associated confidence scores (MappingScore). The mapping correction agent 214 presents these mappings to the human user 204, particularly when the confidence scores are below a predetermined threshold, indicating potential ambiguity or a need for human review.

The behavior of the mapping correction agent 214 is defined by a specific prompt. An example of which is: You are a helpful expert on the specification for USALI (Uniform System of Account for the Lodging Industry). USALI provides guidance on how to classify a hotel transaction by Department and the USALI chart of accounts. You have access to a vector store that you will populate with the JSON string that you will be given as the result of human user corrections. You will ensure all properties are populated and then write the data into the vector store.

This prompt instructs the mapping correction agent 214 to manage the process of incorporating human corrections. Specifically, it receives a JSON string object, as a result of human feedback, regarding the USALI agent 212’s mapping of the hotel transactions. The mapping correction agent 214 updates all properties. It then writes the data into the a vector store in the corrections/semantic search component 224.

The JSON data handled by the mapping correction agent 214 adheres to a predefined schema, which includes fields for "Customer ID" (String), "Account to map" (String), "Account Description" (String), "Amount" (Currency), "Corrected" (Boolean), "USALI Department" (String), "USALI Account" (String), and "MappingScore" (Float). When a human user 204 reviews the mappings and provides a correction, the "Corrected" field is set to "TRUE," and the "USALI Department" and "USALI Account" fields are updated to reflect the corrected mapping. The "MappingScore" can also be adjusted based on the human feedback. The mapping correction agent 214 then stores this updated JSON object in the vector database within the corrections/semantic search component 224. The storage in the vector database facilitates future retrieval and prioritizes human-validated mappings in subsequent processing. This contributes significantly to the system’s adaptive learning and long-term accuracy. The vector database in the corrections / semantic search component 224 then becomes a repository of accumulated knowledge and contributes to reduction of the need for human review.

The PMS Mapper system shown in FIG. 2 may be implemented using the computer system 100 shown in FIG. 1. Specifically, the accounting software 210, USALI agent 212, mapping correction agent 214, corrections/semantic search component 224, USALI RAG component 232, and vectorized USALI PDF 234 may be implemented as software components executing on the host computer 180. The host CPU 182 may execute these components, with the host memory 184 storing the necessary program instructions and data, including the JSON payloads containing the account mapping information shown in FIG. 3. The storage device(s) 185 may store the vector databases used by the corrections/semantic search component 224 as well as the vectorized USALI PDF 234. The component devices 186-1 to 186-N may include network interface hardware allowing the host computer 180 to communicate with human users 204 and receive PMS transaction data over the data network 172.

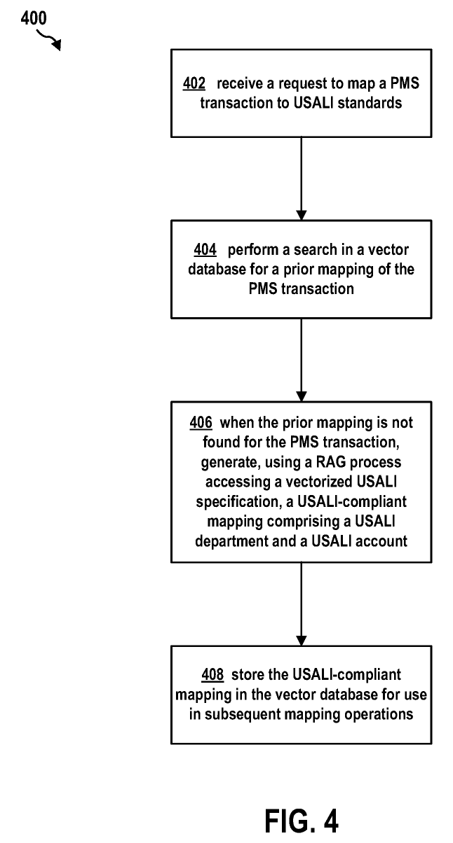

FIG. 4 is a flow chart 400 of a method for mapping PMS transactions to USALI standards. The method may be performed by one or more computing devices (e.g., the host computer 180). In operation 402, the one or more computing devices receive a request to map a PMS transaction to USALI standards. In operation 404, the one or more computing devices perform a search in a vector database for a prior mapping of the PMS transaction. In operation 406, when the prior mapping is not found for the PMS transaction, the one or more computing devices generate, using a retrieval augmented generation (RAG) process accessing a vectorized USALI specification, a USALI-compliant mapping comprising a USALI department and a USALI account. In operation 408, the one or more computing devices store the USALI-compliant mapping in the vector database for use in subsequent mapping operations.

The one or more computing devices assign a confidence score to the USALI-compliant mapping, wherein the confidence score indicates a level of certainty in the accuracy of the USALI-compliant mapping. The one or more computing devices present the USALI-compliant mapping to a user for review when the confidence score is below a predetermined threshold. The one or more computing devices receive a correction to the USALI-compliant mapping from the user and update the vector database with the correction.

In certain configurations, to update the vector database with the correction, the one or more computing devices set a corrected flag associated with the USALI-compliant mapping to indicate that the USALI-compliant mapping has been manually corrected and store the corrected USALI-compliant mapping in the vector database for prioritized retrieval in subsequent mapping operations.

In certain configurations, the search in the vector database comprises a hybrid search combining semantic search and keyword-based search to identify semantically similar prior mappings.

In certain configurations, to generate the USALI-compliant mapping, the one or more computing devices retrieve relevant portions of the vectorized USALI specification based on semantic similarity to the PMS transaction, provide the relevant portions to a large language model (LLM), and receive from the LLM the USALI department and the USALI account for the PMS transaction.

In certain configurations, the PMS transaction is received as part of a batch of transactions, and the one or more computing devices, for each transaction in the batch, determine whether a prior mapping exists in the vector database, when the prior mapping exists, apply the prior mapping to the transaction, and when the prior mapping does not exist, generate a new mapping using the RAG process.

In certain configurations, the PMS transaction comprises an account code and an account description, and to generate the USALI-compliant mapping, the one or more computing devices analyze both the account code and the account description to determine the appropriate USALI department and USALI account.

The one or more computing devices implement a first agent configured to perform the RAG process to generate the USALI-compliant mapping and implement a second agent configured to manage corrections to the USALI-compliant mapping and update the vector database with the corrections.

In certain configurations, the first agent is a USALI agent and is configured with a prompt that defines the first agent as an expert on USALI specifications and instructs the first agent to classify financial transactions based on semantic similarity to USALI accounts.

In certain configurations, the second agent is a Mapping Corrections agent and is configured with a prompt that instructs the second agent to receive human corrections to mappings and update the vector database with the corrected mappings.

The one or more computing devices vectorize the USALI specification by converting textual content of a USALI document into numerical vector representations using an embedding model and storing the numerical vector representations in a format that preserves semantic relationships between different sections of the USALI document.

In certain configurations, the vector database stores mappings from multiple property management systems, and the one or more computing devices identify a specific property management system associated with the PMS transaction and prioritize prior mappings associated with the specific property management system during the search.

It is understood that the specific order or hierarchy of blocks in the processes / flowcharts disclosed is an illustration of exemplary approaches. Based upon design preferences, it is understood that the specific order or hierarchy of blocks in the processes / flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving a request to map a property management system (PMS) transaction to Uniform System of Accounts for the Lodging Industry (USALI) standards;
performing a search in a vector database for a prior mapping of the PMS transaction;
when the prior mapping is not found for the PMS transaction:
generating, using a retrieval augmented generation (RAG) process accessing a vectorized USALI specification, a USALI-compliant mapping comprising a USALI department and a USALI account; and
storing the USALI-compliant mapping in the vector database for use in subsequent mapping operations.

2. The method of claim 1, further comprising:
assigning a confidence score to the USALI-compliant mapping, wherein the confidence score indicates a level of certainty in the accuracy of the USALI-compliant mapping.

3. The method of claim 2, further comprising:
presenting the USALI-compliant mapping to a user for review when the confidence score is below a predetermined threshold;
receiving a correction to the USALI-compliant mapping from the user; and
updating the vector database with the correction.

4. The method of claim 3, wherein updating the vector database with the correction comprises:
setting a corrected flag associated with the USALI-compliant mapping to indicate that the USALI-compliant mapping has been manually corrected; and
storing the corrected USALI-compliant mapping in the vector database for prioritized retrieval in subsequent mapping operations.

5. The method of claim 1, wherein the search in the vector database comprises a hybrid search combining semantic search and keyword-based search to identify semantically similar prior mappings.

6. The method of claim 1, wherein generating the USALI-compliant mapping comprises:
retrieving relevant portions of the vectorized USALI specification based on semantic similarity to the PMS transaction;
providing the relevant portions to a large language model (LLM); and
receiving from the LLM the USALI department and the USALI account for the PMS transaction.

7. The method of claim 1, wherein the PMS transaction is received as part of a batch of transactions, and wherein the method further comprises:
for each transaction in the batch:
determining whether a prior mapping exists in the vector database;
when the prior mapping exists, applying the prior mapping to the transaction; and
when the prior mapping does not exist, generating a new mapping using the RAG process.

8. The method of claim 1, wherein the PMS transaction comprises an account code and an account description, and wherein generating the USALI-compliant mapping comprises analyzing both the account code and the account description to determine the appropriate USALI department and USALI account.

9. The method of claim 1, further comprising:
implementing a first agent configured to perform the RAG process to generate the USALI-compliant mapping; and
implementing a second agent configured to manage corrections to the USALI-compliant mapping and update the vector database with the corrections.

10. The method of claim 9, wherein the first agent is a USALI agent and is configured with a prompt that defines the first agent as an expert on USALI specifications and instructs the first agent to classify financial transactions based on semantic similarity to USALI accounts.

11. The method of claim 9, wherein the second agent is a Mapping Corrections agent and is configured with a prompt that instructs the second agent to receive human corrections to mappings and update the vector database with the corrected mappings.

12. The method of claim 1, further comprising:
vectorizing the USALI specification by:
converting textual content of a USALI document into numerical vector representations using an embedding model; and
storing the numerical vector representations in a format that preserves semantic relationships between different sections of the USALI document.

13. The method of claim 1, wherein the vector database stores mappings from multiple property management systems, and wherein the method further comprises:
identifying a specific property management system associated with the PMS transaction; and
prioritizing prior mappings associated with the specific property management system during the search.

14. A system, including one or more computing devices, comprising:
a memory; and
at least one processor coupled to the memory and configured to:
receive a request to map a property management system (PMS) transaction to Uniform System of Accounts for the Lodging Industry (USALI) standards;
perform a search in a vector database for a prior mapping of the PMS transaction;
when the prior mapping is not found for the PMS transaction:
generate, using a retrieval augmented generation (RAG) process accessing a vectorized USALI specification, a USALI-compliant mapping comprising a USALI department and a USALI account; and
store the USALI-compliant mapping in the vector database for use in subsequent mapping operations.

15. The system of claim 14, wherein the at least one processor is further configured to:
assign a confidence score to the USALI-compliant mapping, wherein the confidence score indicates a level of certainty in the accuracy of the USALI-compliant mapping.

16. The system of claim 15, wherein the at least one processor is further configured to:
present the USALI-compliant mapping to a user for review when the confidence score is below a predetermined threshold;
receive a correction to the USALI-compliant mapping from the user; and
update the vector database with the correction.

17. The system of claim 16, wherein to update the vector database with the correction, the at least one processor is configured to:
set a corrected flag associated with the USALI-compliant mapping to indicate that the USALI-compliant mapping has been manually corrected; and
store the corrected USALI-compliant mapping in the vector database for prioritized retrieval in subsequent mapping operations.

18. The system of claim 14, wherein the search in the vector database comprises a hybrid search combining semantic search and keyword-based search to identify semantically similar prior mappings.

19. The system of claim 14, wherein to generate the USALI-compliant mapping, the at least one processor is configured to:
retrieve relevant portions of the vectorized USALI specification based on semantic similarity to the PMS transaction;
provide the relevant portions to a large language model (LLM); and
receive from the LLM the USALI department and the USALI account for the PMS transaction.

20. A non-transitory computer-readable medium storing computer executable code for operating one or more computing devices, comprising code to:
receive a request to map a property management system (PMS) transaction to Uniform System of Accounts for the Lodging Industry (USALI) standards;
perform a search in a vector database for a prior mapping of the PMS transaction;
when the prior mapping is not found for the PMS transaction:
generate, using a retrieval augmented generation (RAG) process accessing a vectorized USALI specification, a USALI-compliant mapping comprising a USALI department and a USALI account; and
store the USALI-compliant mapping in the vector database for use in subsequent mapping operations.
